(19) United States
(12) Patent Application Publication
(10) Pub. No.: US 2025/0172251 A1
(43) Pub. Date: May 29, 2025

(54) CONDITIONING DEVICE FOR A PRESSURIZED FLUID

(71) Applicant: L'Air Liquide, Societe Anonyme pour l'Etude et l’Exploitation des Procedes Georges Claude, Paris (FR)

(72) Inventors: Benjamin FISCHER, Les Loges en Josas (FR); Denis MULLER, Les Loges en Josas (FR); Cesar JUBERT, Les Loges en Josas (FR)

(21) Appl. No.: 18/956,846

(22) Filed: Nov. 22, 2024

(30) Foreign Application Priority Data
Nov. 29, 2023 (FR) FR 2313260

(51) Int. Cl. F17C 13/04

(52) U.S. Cl. CPC F17C 13/04; F17C 2205/0329; F17C 2223/0123

(57) ABSTRACT

The invention relates to a conditioning device configured to cooperate with a fluid filling or tapping connector of a pressurized fluid container, the conditioning device having a structure extending along a longitudinal axis A, a valve pusher, the valve pusher having a body and at least one protective element arranged on the body, the at least one protective element being intended to come into contact at least in part with a valve of the filling or tapping connector when the valve is opened, the body of the valve pusher being made of a first material and the at least one protective element being made at least in part of a second material, the second material having a hardness lower than the hardness of the first material.

### CROSS-REFERENCE TO RELATED APPLICATIONS

This application claims the benefit of priority under 35 U.S.C. § 119 (a) and (b) to French patent application No. FR 2313260, filed Nov. 29, 2023, the entire contents of which are incorporated herein by reference.

### BACKGROUND

### Field of the Invention

The present invention relates to a conditioning device for a pressurized fluid, a conditioning system comprising such a device and a container, and the use of said device or of said system.

### Related Art

It is known from the prior art to use conditioning devices to tap fluid from a container or to fill said container.

Application FR3101125A1 thus discloses a conditioning device designed to cooperate with a filling and/or tapping connector of a pressurized-fluid container cock, the conditioning device comprising a valve pusher that is movable in a gas transfer line along a longitudinal axis to open at least one valve of the filling connector.

This type of device is used to fill the container or to tap fluid kept under pressure in a container. This type of device requires the valve of a filling and/or tapping connector to be pushed to bring a filling channel of the device into fluidic communication with the container. The displacement of the valve may generate impacts or friction in the filling channel.

In another configuration disclosed in WO13076263A1, the removable cock for pressurized fluid comprises a valve. This valve is a concentric double valve. A first channel and a second channel separate from the first channel are respectively closed by the outer valve and by the inner valve. The first channel is used to fill the container and the second channel is used to tap fluid from the container.

In this configuration, when the valve pusher is actuated to displace the outer valve, a fluidic connection is then created between the first channel and the channel of the conditioning device. During this fluidic connection, the filling flow exerts a force on the inner valve. The force exerted on the inner valve can cause the inner valve to open and apply forces to the elements of the tapping channel. Vibrations of the inner valve and/or friction in this second channel can also be induced. Vibrations can cause premature wear of certain components, such as springs, but also friction generating particles that could contaminate the fluid or damage the sealing areas.

Furthermore, the force applied to push the valve will generate impacts to the surface of the valve or valves.

### SUMMARY OF THE INVENTION

The present invention is intended to efficiently overcome these drawbacks by proposing a conditioning device which limits or even eliminates the damage caused by the use of such a device.

A solution of the invention is a conditioning device configured to cooperate with a fluid filling or tapping connector of a pressurized fluid container, the conditioning device comprising a structure extending along a longitudinal axis A, the conditioning device comprising a valve pusher that is movable along the longitudinal axis A in a fluid transfer line of the structure to open at least one valve of an internal circuit of the fluid filling or tapping connector when the structure is brought into contact with the connector to bring the fluid transfer line into fluidic communication with the internal circuit of the fluid filling or tapping connector, characterized in that the valve pusher comprises a body and at least one protective element arranged on the body, the at least one protective element being intended to come into contact at least in part with the valve when said valve is opened, the body of the valve pusher being made of a first material and the at least one protective element being made at least in part of a second material, the second material having a hardness lower than the hardness of said first material.

Depending on the case, the invention may comprise one or more of the features set out below.

The body comprises at least one downstream surface extending generally orthogonally to the longitudinal axis A, and the at least one protective element is arranged on the downstream surface.

The body comprises at least one lateral surface extending along the longitudinal axis A, and the at least one protective element is arranged on the lateral surface.

The body comprises a protuberance extending along the longitudinal axis A, at least a portion of the protuberance projects into an internal recess of the valve when the valve is opened, and the at least one protective element is arranged on a surface of said protuberance.

The at least one protective element is arranged in at least one groove formed on an outer surface of the body.

The at least one protective element is a surface coating deposited on at least a portion of an outer surface of the body.

The at least one protective element forms a sleeve about said body, at least partially covering an outer surface of the body.

The at least one protective element is composed of a discontinuous set of elements arranged on the body, for example the elements are crimped onto the body.

The second material has a hardness of between 25 Hv and 90 Hv on the Shore A scale or between 30 Hv and 70 Hv on the Shore D scale.

The second material is selected from: a polytetrafluoroethylene, a polyoxymethylene, a rubber or a polyurethane.

The at least one protective element is made in part of a third material, the third material having a hardness lower than the hardness of the first material.

The at least one protective element comprises at least one O-ring, which is for example overmoulded or vulcanized.

The invention also relates to a conditioning system for a pressurized fluid container comprising:
a conditioning device according to the invention,
a fluid filling or tapping connector of a pressurized fluid container, said connector comprising:
a first end configured to be connected to the conditioning device and comprising a valve, the valve being opened by the displacement of the valve pusher on the valve,
a second end configured to be connected to a pressurized fluid container,
a fluid circuit arranged between said first end and said second end.

The invention also relates to the use of the conditioning device according to the invention or of the system according to the invention for tapping and/or filling a pressurized fluid container, notably a pressurized gas cylinder.

### BRIEF DESCRIPTION OF THE FIGURES

The invention will be understood better from reading the following description and from studying the accompanying figures. These figures are given only by way of illustration and do not in any way limit the invention.

FIG. 1 is a schematic view in cross section of one embodiment of a device according to the prior art;

FIG. 2 is a schematic view in cross section of a first embodiment of the device according to the invention;

FIG. 3 is a schematic view in cross section of a second embodiment of a device according to the invention.

### DETAILED DESCRIPTION OF THE INVENTION

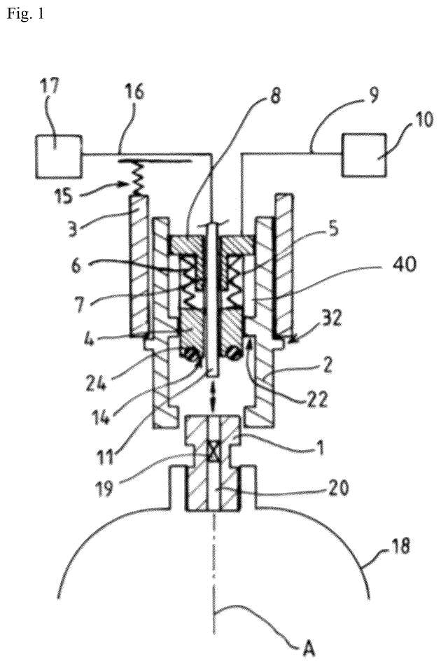

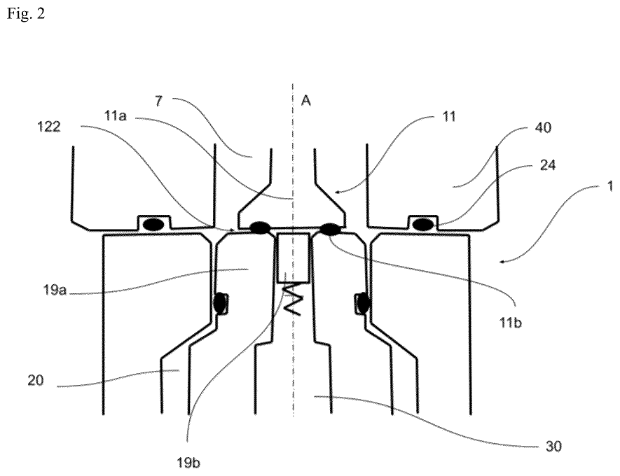

With reference to [FIG. 2] and [FIG. 1], the conditioning device comprises a structure 40 extending along a longitudinal axis A. Depending on the case, the conditioning device may perform an interface function between a fluid source and a container 18 with a view to introducing into it the fluid in the conditioning device. In another case, the conditioning device is connected solely to the container 18 and can then perform the function of a tool for tapping the fluid from the container 18. The fluid is for example a cryogenic gas, for example carbon dioxide at between 0° C. and −40° C. In another case, the conditioning device can perform an interface function between a fluid receiver and a container 18. Thus, when the fluid is tapped from the container 18, the fluid is recovered in the receiver. This may be the case for example to prevent gases, for example carbon dioxide, being discharged into the atmosphere.

For this purpose, the conditioning device comprises a valve pusher 11 that is movable along the longitudinal axis A in a fluid transfer line 7 of a structure 40. The valve pusher 11 opens at least one valve 19, 19a, 19b of a fluid filling and/or tapping connector 1. The connector 1 comprises a first end 122 configured to be connected to the conditioning device. The second end of the filling or tapping connector 1 is mounted on a container 18 for storing pressurized fluid, for example a gas cylinder. The connector 1 comprises a first internal circuit 20 housing at least one valve 19, 19a, 19b for closing the internal circuit. It is the first internal circuit 20 which is brought into fluidic communication with the container 18 and the fluid transfer line 7. When the structure 40 is brought into contact with a first end 122 of the connector 1, a user can actuate the valve pusher 11 in such a way that the valve pusher 11 applies a force to at least one valve 19, 19a, 19b to open it. It is understood that this actuation can be carried out manually or automatically. For example, according to the embodiment in [FIG. 1], when the valve 19 is opened, the fluid transfer line 7 is in fluidic communication with the first internal circuit 20 of the fluid filling or tapping connector 1. The user can then tap the fluid from the container 18 via the first internal circuit 20 of the connector 1. When the structure 40 is connected by another end to a fluid source, the user can then fill the container 18 by introducing fluid into the first internal circuit 20 of the connector.

According to one embodiment of the invention, the structure 40 comprises, on the surface of the first end intended to be in contact with the connector 1, a gasket 24 arranged about the longitudinal axis A.

In one embodiment, the gasket 24 is an O-ring intended to create an external seal between the body of the filling connector 40 and the body of the connector 1. In one embodiment, this gasket 24 is a seal produced by overmoulding or vulcanization. Thus, when the conditioning device is intended to be used at low temperatures, for example from 0° C. to −20° C., the gasket 24 remains connected to the body 40 and not bonded to the surface of the connector 1 when the valve pusher 11 is lifted, for example.

According to one embodiment, the filling connector comprises a second internal circuit 30 housing at least one valve 19b for closing the internal circuit 30 and the internal circuit 30 can be brought into fluidic communication with the container 18 and the fluid transfer line 7. This may be the case for example when two valves are concentric. The filling or tapping connector 1 then comprises a closing valve 19 which is a double valve with two concentric closing elements. The valve 19 then comprises for example a valve 19a for filling and a valve 19b for tapping, for example. The valve 19a is thus used to close the first internal circuit 20 and the valve 19b is used to close the second internal circuit 30. In one embodiment, each of the valves 19a and 19b is used for tapping and/or filling, for example at different flow rates.

The valve pusher 11 comprises a body 11a and at least one protective element 11b arranged on the body 11a. The body 11a is intended to be in contact with at least a part of the surface of the valve 19, 19a, 19b to enable the valve 19, 19a, 19b to be opened.

The body 11a of the valve pusher 11 is made of a first material, for example brass or stainless steel. The protective element 11b is made at least in part of a second material. The second material has a hardness lower than the hardness of the first material. This second material is then used to absorb the impacts in order to protect the valve 19, 19a, 19b, the connector 1 and/or the walls forming the first internal circuit 20 and the second internal circuit 30. According to the embodiment, this second material also creates a seal between the valve pusher and the internal circuit 20, 30.

According to one embodiment, the second material has a hardness of between 25 Shore A and 90 Shore A or between 30 Shore D and 70 Shore D, the hardness being measured for example according to ISO standard 48:2010, for elastomers.

The second material is for example a plastic such as a polytetrafluoroethylene, a polyoxymethylene, an ethylene propylene diene monomer rubber, or a polyurethane. In one embodiment, the second material is more particularly a rubber. A rubber permits greater elastic deformation and therefore increased resistance to impacts, thereby further reducing the wear of the valve pusher 11 and/or of the connector 1.

In one embodiment, the protective element 11b notably creates a seal between the internal circuit 30 and the fluid transfer line 7. Thus, when the user actuates the valve 19, 19a, the protective element 11b prevents the tapping or filling flow from exerting excessive force on the valve 19b. In one embodiment, the protective element 11b absorbs the impacts of the valve pusher 11 against the valve 19, 19a. In one embodiment, the protective element 11b creates a seal between the internal circuit 30 and the fluid transfer line 7 and absorbs the impacts of the valve pusher 11 against the valve 19, 19a.

According to one embodiment, said body 11a of the valve pusher 11 comprises at least one lateral surface that extends along the longitudinal axis A. At least one protective element 11b is arranged on said lateral surface. Thus, when the valve pusher 11 enters the filling connector to actuate the valve 19, 19a, 19b, the protective element 11b will limit the friction in the filling connector and absorb the impacts of the valve pusher 11 against the valve 19, 19a, 19b. In one embodiment, the protective element 11b will create a seal between the internal circuit 30 and the fluid transfer line 7.

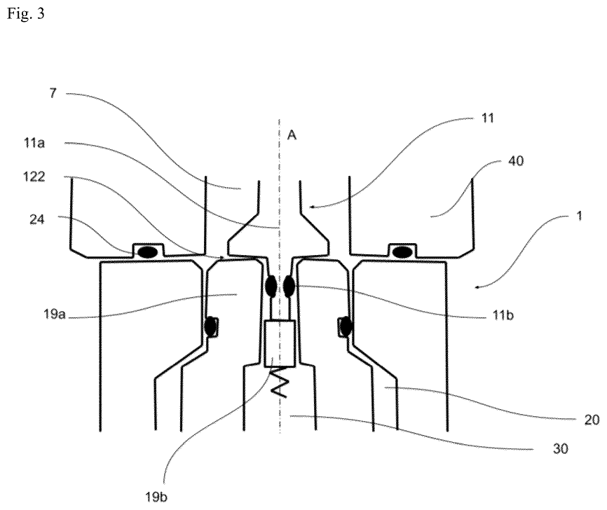

With reference to [FIG. 3], the body 11a comprises a protuberance extending along the longitudinal axis A. At least a portion of the protuberance projects into an internal recess of said valve 19, 19a, 19b when said valve 19, 19a, 19b is opened. This may also be the case for example when two valves are concentric. The filling connector 1 then comprises a closing valve 19 which is a double valve with two concentric closing elements. The valve 19 then comprises a valve 19a and a valve 19b.

Thus, depending on the configuration of the valve pusher 11, the user can choose to actuate one of the valves 19, 19a, 19b or all of the valves 19, 19a, 19b using a single valve pusher 11. At least one protective element 11b is arranged on a lateral surface of said protuberance. In one embodiment, when the valve 19a is actuated, this protective element 11b prevents the tapping or filling flow from exerting excessive force on the valve 19b by creating a seal between the internal channel 30 and the fluid transfer line 7. In fact, the fluid coming from the filling from the transfer line 7 cannot exert any force in the tapping channel 30. The positioning of the protective element 11b on the lateral surface improves the hold of the protective element 11b.

When the protuberance enters the filling connector in order to actuate a valve 19, 19a, 19b, the protective element 11b will also limit friction and impacts in the filling or tapping connector. This prevents damage to the surfaces, for example the sealing surfaces. The seal between the surfaces of the valve 19, 19a, 19b and the valve pusher 11 is protected.

In another embodiment, the valves 19a and 19b can be actuated in series. For example, the valve pusher 11 actuates the valve 19b which for example enables fluid to be tapped at a given flow rate. If the user requires a greater flow rate, for example, the user then actuates the valve pusher 11 to open the valve 19a. In this embodiment, the protective element 11b prevents the impacts and friction between the valve pusher 11 and the valve 19a, 19b.

According to one embodiment, the protective element 11b is arranged in at least one groove formed on an outer surface of the body 11a. This makes the mounting of the protective element 11b easy. The user can replace the protective element 11b alone, if said element becomes worn.

According to another embodiment, the protective element 11b is a compression seal mounted in a groove on an outer surface of the body 11a.

In one embodiment, the protective element 11b is a seal made by overmoulding. In one embodiment, the protective element 11b is a vulcanized seal. Thus, when the conditioning device is intended to be used at low temperatures, for example from 0° C. to −20° C., the protective element 11b does not adhere to the surface of the valve 19a.

According to another embodiment, the protective element 11b is a surface coating deposited on at least a portion of an outer surface of the body. This coating may be a powder deposit, for example a polymethyl methacrylate powder, or a thermosetting coating produced by bonding or spraying. The advantage is that the coating can be temporary, for example used for testing.

According to another embodiment, the protective element 11b may be in the form of a sleeve which surrounds the body 11a. Advantageously, this sleeve at least partially covers the outer surface of the body 11a. The protective element 11b is then a wearing part that is easily replaced and easily mounted about the body 11a without the need for special tooling.

According to another embodiment, the protective element 11b is composed of a discontinuous set of elements arranged on said body 11a, for example the elements are crimped onto said body 11a. This set of discontinuous elements absorbs impacts and friction at precise locations. This may be the case when the filling connector has a complex shape. These locations are predetermined during the design of the connector 1 and of the filling device.

According to another embodiment, the protective element 11b is made in part of a third material, the third material having a hardness lower than the hardness of the first material. For example, the protective element 11b is formed by a first part made of rubber and a second part made of polyetheretherketone. The first part of the protective element 11b absorbs the impact of the downstream surface of the valve pusher 11 on the filling or tapping connector 1. The second part of the protective element 11b reduces, or even eliminates, the friction of the protuberance with the inner surface of the connector 1.

With reference to [FIG. 1], the illustrated conditioning device is designed to cooperate with a filling (and/or tapping) connector 1 of a pressurized fluid container 18. The fluid can be conditioned at a pressure of between 50 and 300 bar.

According to one embodiment, the conditioning device comprises at least one engagement member 2 arranged about a longitudinal axis A. The conditioning device may comprise several engagement members 2. The surface of the engagement members 2 is turned towards the central space intended to receive a filling connector 1 may be provided with relief(s) and/or hollows of determined dimensions. These relief(s) and/or hollows are spaced apart from one another in a determined manner so as to fit into one or more mating slots and/or reliefs formed on the outer face of a filling connector 1. The central space situated between the engagement members 2 and the longitudinal axis A forms a seat intended to receive a filling connector 1 of generally cylindrical shape. The engagement members 2 are movable between a separated position to enable a connector 1 to be inserted into the central space or a connector 1 to be removed from the central space, and a closed position to engage the engagement members 2 with the filling connector 1.

In particular, the conditioning device may further comprise a locking member 3 that is movable relative to the structure 40 and relative to the engagement member 2 between a first active position blocking the at least one engagement member 2 in the closed position (for example) and a second inactive position enabling the engagement members 2 to move towards the separated position.

The locking member 3 may be movable in translation (in a direction parallel to the longitudinal axis A) between the first active position and the second inactive position. Furthermore, the locking member 3 is preferably urged towards the active position thereof by a return member 15 such as a spring. Furthermore, when the engagement members 2 are in the separated position, a stop 32 can prevent the locking member 3 from moving from the inactive position to the active position. By contrast, when the engagement members 2 are in the closed position, the locking member 3 is not prevented from moving from the inactive position to the active position by the stop 32. As illustrated, this stop may be formed by or on one or more members 2.

For example, the locking member 3 comprises or is constituted by a sleeve 3 having a generally tubular shape arranged about the engagement claws 2.

In one embodiment, the valve pusher 11 is actuated by an actuating device 16, 17 which may comprise a switch 17 constituted by a pushbutton or a pivoting lever and a mechanism 16 for transmitting force between the switch 17 and the valve pusher 11. For example, a pivoting lever 17 can control the position of the valve pusher 11 via a cam 16.

The structure 40 may also comprise a member 4 for blocking the members 2. The blocking member 4 is for example mounted on the structure 40 about the terminal (upstream) end of the fluid transfer line 7. The blocking member 4 is movable in translation in a direction parallel to the longitudinal axis A between a first upstream position preventing the displacement of the engagement members 2 from the separated position to the closed position, for example by separating them, and a second downstream position allowing the displacement of the engagement members 2 from the separated position to the closed position, for example where the separation is not maintained.

The blocking member 4 may therefore form or not form, depending on the position thereof, a mechanical stop separating or not separating the engagement members 2 in order to prevent or permit the mechanical connection of the conditioning device to a connector 1.

The blocking member 4 is urged by default towards the working position thereof by a return member 6, for example a spring.

The blocking member 4 is movable from the working position thereof to the idle position thereof during application of a pushing force of the filling connector 1 on the upstream face thereof. In other words, when the conditioning device is pressed against the terminal end of a connector 1, the filling connector 1 enters the central space of the conditioning device and pushes this blocking member 4 downstream. The blocking member 4 then comes into contact with the filling or tapping connector 1.

According to an advantageous feature, the upstream face of the blocking member 4 of the structure 40 comprises the gasket 24 arranged about the longitudinal axis A to form a seal between the gas transfer line 7 and an internal circuit 20 of a filling connector 1.

Thus, this blocking member 4 performs a dual function: a role in the locking mechanism of the quick connection between the conditioning device and the filling connector 1 and a sealing role in this connection. As explained in greater detail below, the blocking member 4 notably seals the connection from the beginning of the actuation of the quick connection and notably during the backwards movement thereof in the downstream direction to release the engagement members 2. In this respect, the blocking member 4 can be considered to be a part of the mechanism for locking the quick connection with the connector 1. The blocking member 4 therefore participates both in the coupling state of a conditioning device to the connector 1 and the sealing thereof.

Preferably, the engagement of the conditioning device on the filling connector 1 can be locked automatically. For example, an operator or a machine presses the conditioning device onto the filling connector 1. During this connection, there is a contact between the blocking member 4 and the face of said filling connector 1 in which the gasket 24 of the blocking member 4 of the structure 40 creates a seal between the line 7 of the conditioning device and the internal circuit 20 of the filling connector 1. During this pressing, the blocking member 4 is pushed back towards the idle position thereof by the conditioning device and the filling connector 1 moving towards one another. This enables the displacement of the locking members 2 which can be forced to move from the separated position to the closed position by the force of the locking member 3 pushed by the spring 5 thereof. When the locking members 2 are brought together (engagement on the body of the filling connector 1), said members no longer impede the movement of the locking member 3 which can then move from the active position thereof to the active locking position thereof under the action of the return member 15.

As illustrated, the conditioning device preferably comprises a member 8 for pushing the blocking member 4, notably to increase the bearing force of the blocking member 4 on the filling connector 1 (and therefore the sealing strength of the seal 24). The blocking member 4 can therefore perform an additional function of keeping the seal under increased pressure.

This pushing member 8 is a part that has for example the general shape of a disc or a cup or a cap. This pushing member 8 is mounted moveably in a direction parallel to the longitudinal axis A between a first downstream position and a second upstream position. These two positions generate forces of different intensity on the blocking member 4 in the upstream direction. The conditioning device further comprises a device 9, 10 for actuating the pushing member 8 configured to control the displacement of the pushing member 8 between the first and second positions thereof. For example, this actuating device 9, 10 is mechanical and/or pneumatic and/or magnetic and/or hydraulic, and comprises a switch 10 that can be actuated manually and/or automatically. Preferably, this device 9, 10 for actuating the pushing member 8 comprises a switch 10 constituted by a pushbutton or a pivoting lever and a mechanism 9 for transmitting force between the switch 10 and the pushing member 8.

In one possible embodiment, the displacement of the pushing member 8 could be controlled automatically, for example as a function of the state of mechanical connection between the conditioning device and the connector 1 (engagement member 2 and locking member 3).

The invention also relates to a conditioning system for a pressurized fluid container, typically at between 50 bar and 300 bar. The conditioning system comprises the conditioning device according to the invention. The conditioning system comprises a fluid filling or tapping connector 1 of a pressurized fluid container 18. The connector 1 comprises a first end 122 configured to be connected to the conditioning device, for example using an engagement member 2. The connector 1 comprises a valve 19, 19a, 19b, and the valve can be opened by the displacement of the valve pusher 11 bearing on the valve 19, 19a, 19b. The valve pusher 11 pushes the valve 19, 19a, 19b with a force which can be predefined. The connector 1 comprises a second end configured to be connected to a pressurized fluid container 18, for example by means of a thread. The connector 1 comprises a fluid circuit 20 arranged between said first end 122 and said second end. The fluid circuit 20 allows the fluid to pass through the connector 1 in order to fill the container 18 with the fluid or to tap the fluid from the container 18.

The invention also relates to the use of the conditioning device according to the invention or of the system according to the invention for tapping and/or filling a pressurized fluid container 18, notably a pressurized gas cylinder. The user places the structure 40 on the filling or tapping connector 1. The user then actuates the valve pusher 11 which opens the valve 19, 19a, 19b. The first internal circuit 20 is then brought into fluidic communication with the fluid transfer line 7. The gas can then be transferred. As described above, the conditioning device of the invention can be used either to fill the container 18 or to tap the fluid from the container 18. The gasket 24 creates a seal between the fluid transfer line 7 and the first internal circuit 20. The at least one protective element 11b protects the surface of the valve pusher 11 and/or the surface of the cock 1 from impacts and/or friction.

With reference to [FIG. 1], the mechanical and fluidic connection can in particular be made according to the following sequence:

The conditioning device is threaded onto the filling connector 1, which creates a sealing contact between the blocking member 4 and the inlet of the internal circuit 20 of the connector 1, the backward movement of the blocking member 4 in the downstream direction releases the engagement members 2 which can engage with the body of the connector 1, this automatically enables the movement of the member 3 which secures and locks the mechanical connection, the gasket 24 of the blocking member 4 is placed under increased pressure by actuating the switch 10 of the device for actuating the position of the pushing member 8 (for example via a lever and cam(s) and the spring 6), if necessary, the seal of the connection can be checked by placing the assembly under vacuum, the isolating valve or valves 19 of the connector 1 can then be opened by the valve pusher 11 controlled by a switch 10 (a second lever for example acting via a cam on the valve pusher seated in the transfer line 7), the gas can then be transferred between the two connected entities. After gas transfer, disconnection can be performed notably according to the following sequence:

The valve or valves 19, 19a, 19b closing the connector 1 can be closed by the displacement of the valve pusher 11 in the opposite direction (downstream) via the switch 10, the internal circuit 20, 30 can be bled, the crushing force of the gasket 24 of the blocking element 4 is reduced by actuating the switch 10 of the device (displacement of the pushing member 8 in the opposite direction), the mechanical connection between the conditioning device and the connector 1 can be unlocked by the displacement of the locking member 3 and separation of the engagement members 2.

Of course, the invention is not limited to the example embodiments described above. Thus, for example, a mechanism or device may be provided for locking/unlocking the control switch 17 of the valve pusher 11 which prevents actuation thereof (thereby preventing the valves 19, 19a, 19b from opening) as long as the gasket 24 of the blocking part is not pressurized (via the actuator 10). This can be provided using a mechanical and/or hydraulic and/or pneumatic and/or magnetic system. For example, the actuation of the two actuators 10, 17 can be coupled and notably the actuator 17 is accessible or displaceable only if the other actuator 10 is in the required position. In a variant, the two operations (pressurization of the seal 24 and opening of the valves 19) may be sequential and performed by one and the same switch (lever or the like).

Similarly, a mechanism or device may be provided for locking/unlocking the pressurization of the gasket 24 (and optionally of the locking member 3) as a function of the pressure in the circuit or circuits 7, 20. In other words, for example, the member 8 cannot return to the first downstream position thereof if the system detects a pressure above a determined threshold in the circuit (meaning for example that the valve 19, 19a, 19b is not closed). The same applies to the locking member 3, which could be blocked in the first active position thereof as long as the pressure in the circuits 7, 20, 30 is above a determined threshold.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. Conditioning device configured to cooperate with a fluid filling or tapping connector (1) of a pressurized fluid container, said conditioning device comprising a structure (40) extending along a longitudinal axis A, the conditioning device comprising a valve pusher (11) that is movable along the longitudinal axis A in a fluid transfer line (7) of said structure (40) to open at least one valve (19, 19a, 19b) of an internal circuit (20, 30) of the fluid filling or tapping connector (1) when the structure (40) is brought into contact with the connector (1) to bring the fluid transfer line (7) into fluidic communication with the internal circuit (20, 30) of the fluid filling or tapping connector (1), characterized in that the valve pusher (11) comprises a body (11a) and at least one protective element (11b) arranged on said body (11a), said at least one protective element (11b) being intended to come into contact at least in part with said valve (19, 19a, 19b) when said valve (19, 19a, 19b) is opened, said body (11a) of the valve pusher (11) being made of a first material and said at least one protective element (11b) being made at least in part of a second material, said second material having a hardness lower than the hardness of said first material.

2. Conditioning device according to claim 1, characterized in that said body (11a) comprises at least one downstream surface extending generally orthogonally to the longitudinal axis A, said at least one protective element (11b) being arranged on said downstream surface.

3. Conditioning device according to any one of the preceding claims, characterized in that said body (11a) comprises at least one lateral surface extending along the longitudinal axis A, said at least one protective element (11b) being arranged on said lateral surface.

4. Conditioning device according to any one of the preceding claims, characterized in that said body (11a) comprises a protuberance extending along the longitudinal axis A, at least a portion of said protuberance projecting into an internal recess of said valve (19, 19a, 19b) when said valve (19, 19a, 19b) is opened, said at least one protective element (11b) being arranged on a surface of said protuberance.

5. Conditioning device according to any one of the preceding claims, characterized in that said at least one protective element (11b) is arranged in at least one groove formed on an outer surface of the body.

6. Conditioning device according to any one of the preceding claims, characterized in that said at least one protective element (11b) is a surface coating deposited on at least a portion of an outer surface of the body.

7. Conditioning device according to any one of the preceding claims, characterized in that said at least one protective element (11b) forms a sleeve about said body (11a), at least partially covering an outer surface of the body (11a).

8. Conditioning device according to any one of the preceding claims, characterized in that said at least one protective element (11b) is composed of a discontinuous set of elements arranged on said body (11a), for example the elements are crimped onto said body (11a).

9. Conditioning device according to any one of the preceding claims, characterized in that the second material has a hardness of between 25 Hv and 90 Hv on the Shore A scale or between 30 Hv and 70 Hv on the Shore D scale.

10. Conditioning device according to any one of the preceding claims, characterized in that the second material is selected from: a polytetrafluoroethylene, a polyoxymethylene, a rubber or a polyurethane.

11. Conditioning device according to any one of the preceding claims, characterized in that said at least one protective element (11b) is made in part of a third material, said third material having a hardness lower than the hardness of said first material.

12. Conditioning device according to any one of the preceding claims, characterized in that said at least one protective element (11b) comprises at least one O-ring, which is for example overmoulded or vulcanized.

13. Conditioning system for a pressurized fluid container, characterized in that it comprises:
a conditioning device according to any one of the preceding claims,
a fluid filling or tapping connector (1) of a pressurized fluid container, said connector comprising:
a first end (122) configured to be connected to the conditioning device and comprising a valve (19, 19a, 19b), the valve being opened by the displacement of the valve pusher (11) on the valve (19, 19a, 19b),
a second end configured to be connected to a pressurized fluid container (18),
a fluid circuit arranged between said first end and said second end.

14. Use of the conditioning device according to any one of claims 1 to 12 or of the system according to claim 13 for tapping and/or filling a pressurized fluid container, notably a pressurized gas cylinder.
